(19) United States
(12) Patent Application Publication
(10) Pub. No.: US 2026/0026655 A1
(43) Pub. Date: Jan. 29, 2026

(54) KITCHEN APPLIANCE WITH DETACHABLE PULL STRING DRIVE DEVICE

(71) Applicant: SEB S.A., Ecully (FR)

(72) Inventors: Stéphane Plichon, Ecully Cedex (FR); David Benoit, Ecully Cedex (FR)

(73) Assignee: SEB S.A., Ecully (FR)

(21) Appl. No.: 18/713,003

(22) PCT Filed: Nov. 23, 2022
(86) PCT No.: PCT/FR2022/052166

§ 371 Date: May 23, 2024

(30) Foreign Application Priority Data
Nov. 26, 2021 (FR) 21/12565

(51) Int. Cl. A47J 43/08; A47J 19/00; A47J 43/044; B01F 35/32; B01F 101/00

(52) U.S. Cl. CPC A47J 43/082; A47J 19/00; A47J 43/044; B01F 35/3202; B01F 35/3214; A47J 2043/04454; B01F 2101/1805

(57) ABSTRACT

A kitchen appliance includes a work unit having a bowl, a lid and a rotary accessory rotatable around a rotational axis; a pull string drive device including a main body, a drive wheel housed in the main body, a string configured to be wound around the drive wheel, and a handle connected to the string, the pull string drive device being configured to manually rotate the rotary accessory by pulling the string transversely to the rotational axis; and a locking system configured to fasten the main body temporarily and reversibly to the lid, and to prevent rotational movement of the main body relative to the lid and along the rotational axis.

The field of the invention is that of non-electric, manually-operated, self-retracting cable reels for transmitting movement from one part to another part by pulling a cable or string.

There are already known pull string drive mechanisms intended to transmit a rotational movement to an object or a work unit. These mechanisms are often used as handheld drive devices in household appliances such as kitchen appliances, like salad spinners, choppers, ricers, juicers or blenders.

Document US2008/0164357 discloses a kitchen appliance with a manually-operated pull string. This kitchen appliance makes it possible to chop food by rotating cutting blades when the user pulls on a handle connected to a string.

The kitchen appliance described in US2008/0164357 is more specifically equipped with a manually-operated pull string drive mechanism arranged inside the lid of the kitchen appliance. This drive mechanism is complex to assemble because the parts of the drive mechanism cooperate with each other and can be put together only while assembling the lid of the kitchen appliance. One of the drawbacks is that once the drive mechanism has been positioned in the lid, it is no longer accessible and is permanently attached when in use to the lid inside which it is installed. It is therefore impossible to release or move the drive mechanism which is secured in the lid and permanently connected to the lid.

Another drawback is that assembling this kind of drive mechanism in the lid is tedious and complex and cannot be automated. The kitchen appliance assembly therefore cannot be separated from the drive mechanism assembly.

The present invention aims to remedy the aforementioned drawbacks and to provide a kitchen appliance with a simple, removable, manually-operated pull string drive device that is separate from the rest of the appliance.

The invention relates to a kitchen appliance, comprising:
a work unit comprising a bowl, a lid configured to close the bowl and a rotary accessory arranged in the bowl and rotatably mounted around a rotational axis;
a pull string drive device comprising a main body, a drive wheel housed in the main body and configured to be arranged coaxially relative to the rotational axis, a string that is configured to be wound around the drive wheel and that comprises a first end fastened to the drive wheel and a second end opposite the first end, and a handle connected to the second end of the string and configured to pull on the string so as to rotate the drive wheel in one direction of rotation, the pull string drive device being configured to manually cause the rotary accessory to rotate around the rotational axis by pulling the string transversely to the rotational axis;
characterized in that the pull string drive device is self-contained and is configured to be removable relative to the lid, and in that the kitchen appliance comprises a locking system configured to fasten the main body of the pull string drive device temporarily and reversibly to the lid, the locking system being further configured to prevent, and more specifically to prohibit, rotational movement of the main body relative to the lid and along the rotational axis when the main body is fastened to the lid.

The term “removable” is to be understood to mean that the user can remove the pull string drive device from the lid without disassembling it and can replace the pull string drive device on the lid, either temporarily or permanently.

The pull string drive device of the kitchen appliance according to the invention offers the advantage of being easily adaptable to kitchen appliances of all shapes and geometries and of being manufactured separately from the rest of the bowl and of the lid of the kitchen appliance. Accordingly, the pull string drive device of the kitchen appliance according to the invention is stand-alone and ready for operation at any time. The pull string drive device of the kitchen appliance according to the invention is fully accessible, as it is not pre-assembled in the lid, which would limit its handling.

Moreover, the pull string drive device of the kitchen appliance according to the invention offers the advantage of being a self-contained, releasable subassembly, meaning that it is configured to be movable from one kitchen appliance to another, or even replaceable or repairable. Indeed, the pull string drive device of the kitchen appliance according to the invention could conceivably be released and then moved from one lid to another lid by releasing it from the lid of the bowl, without disassembling the pull string drive device or acting on the tension of the string. The pull string drive device according to the present invention is therefore versatile.

A further advantage of the invention is that the pull string drive device is designed to be manufactured and transported separately from the rest of the kitchen appliance in which it will be used, thus providing a high degree of industrial autonomy.

Yet another advantage of the invention is that the work unit can be detached from the pull string drive device, and thus washed separately from the pull string drive device, for example in a dishwasher.

In addition, the risk of contact between the food in the work unit and the pull string drive device is greatly reduced by the fact that the lid forms an interface between the drive part of the kitchen appliance and its food part, which limits the risk of food splashing and soiling of the pull string drive device.

The specific configuration of the locking system further ensures that the forces applied to the main body (each time the string is pulled) are absorbed by the lid and not by the coupling means configured to transmit the rotation of the drive wheel to the rotary accessory, which protects the integrity of these coupling means and therefore of the kitchen appliance.

The specific configuration of the locking system considerably reduces the risk of inadvertent disconnection between the pull string drive device and the lid, for example when a user pulls on the string, which is oriented tangentially relative to the rotational axis and which therefore generates a torque on the main body.

The kitchen appliance according to the invention can also have one or more of the following features, taken alone or in combination.

According to one embodiment of the invention, the rotary accessory is a rotary processing tool configured to process food received in the bowl and, for example, to mix, beat, whisk, grate, chop, cut, blend, combine, emulsify and/or knead food received in the bowl, when a user pulls on the handle connected to the string.

According to one embodiment of the invention, the pull string drive device comprises a return spring housed in the inner housing delimited by the main body and configured to be arranged coaxially relative to the rotational axis, the return spring being configured to rotate the drive wheel in a reverse direction of rotation that is opposite to the direction of rotation. Advantageously, the direction of rotation corresponds to unwinding the string from the drive wheel, and the reverse direction of rotation corresponds to winding the string around the drive wheel.

According to one embodiment of the invention, when the main body is fastened to the lid, the locking system is configured to prevent translational movement of the main body relative to the lid in a direction of travel that is parallel to the rotational axis, and translational movement of the main body relative to the lid in a plane of travel that is orthogonal to the rotational axis. These provisions further limit the risk of inadvertent disconnection between the pull string drive device and the lid (for example, if the kitchen appliance is lifted by gripping the pull string drive device), and also limit the risk of misalignment of the rotary accessory and of the drive wheel when using the kitchen appliance.

According to one embodiment of the invention, the locking system is configured to immobilize the main body in translation and in rotation relative to the lid when the main body is fastened to the lid.

According to one embodiment of the invention, the locking system comprises a fastening device configured to fasten the main body of the pull string drive device temporarily and reversibly to the lid, the fastening device comprising at least one fastening member provided on the main body and at least one fastening component provided on the lid, the at least one fastening member being configured to occupy a fastening position in which the at least one fastening member is configured to cooperate with the at least one fastening component so as to fasten the main body to the lid, and a release position in which the at least one fastening member is configured to release the at least one fastening component so that the pull string drive device can be removed from the lid.

According to one embodiment of the invention, the at least one fastening member is arranged in a lower part of the main body.

According to one embodiment of the invention, the fastening device is configured to prevent translational movement of the main body relative to the lid in the direction of travel.

According to one embodiment of the invention, the at least one fastening member is mounted so as to be movable relative to the main body between the fastening position and the release position.

According to one embodiment of the invention, the at least one fastening member is hinged to the main body around a hinge pin that is configured to be substantially parallel to the rotational axis when the main body is fastened to the lid.

According to one embodiment of the invention, the at least one fastening member is a fastening bracket, a fastening pin or a fastening clamp.

According to one embodiment of the invention, the fastening device comprises a return means configured to return the at least one fastening member to the fastening position.

According to one embodiment of the invention, the kitchen appliance comprises an actuating mechanism configured to move the at least one fastening member into the release position when the actuating mechanism is operated by a user.

According to one embodiment of the invention, the locking system is configured so that removal of the pull string drive device from the lid comprises a first phase in which the at least one fastening member is moved into the release position by actuating the actuating mechanism, and a second phase in which the main body is translationally moved relative to the lid in the direction of travel.

According to one embodiment of the invention, the actuating mechanism is provided on the pull string drive device.

According to one embodiment of the invention, the actuating mechanism is at least partly housed in the main body and comprises an actuating part configured to project through an opening in the body provided on an outer wall of the main body, and for example on an outer peripheral wall of the main body.

According to one embodiment of the invention, the main body comprises a lower housing that opens into a lower face of the main body, the lower housing being configured to accommodate at least in part the at least one fastening component provided on the lid when the main body is fastened to the lid. In other words, the lower housing is open downwards, meaning towards the lid, when the main body is fastened to the lid.

According to one embodiment of the invention, the lower housing has a polygonal cross-section, for example hexagonal.

According to one embodiment of the invention, the at least one fastening member is configured to project into the lower housing when the at least one fastening member occupies the fastening position.

According to one embodiment of the invention, the fastening device comprises two fastening members, and for example two fastening clamps, mounted so as to be movable relative to the main body between a fastening position in which the first and second fastening members are close to each other and are configured to cooperate with the at least one fastening component provided on the lid, and a release position in which the two fastening members are spaced apart from each other and are configured to release the at least one fastening component. Advantageously, the two fastening members, and for example the two fastening clamps, are arranged opposite each other.

According to one embodiment of the invention, the at least one fastening component comprises a fastening hole configured to accommodate at least in part the at least one fastening member when the at least one fastening member occupies the fastening position. The at least one fastening component may, for example, be a bracket provided with a fastening hole or a fastening hoop delimiting a fastening hole.

According to one embodiment of the invention, the locking system comprises a rotation-locking device configured to prevent, and more specifically to prohibit, rotational movement of the main body relative to the lid and along the rotational axis when the main body is fastened to the lid, the rotation-locking device comprising at least one rotation-locking member provided on the main body and at least one rotation-locking component that is provided on the lid and that is configured to cooperate with the at least one rotation-locking member when the main body is fastened to the lid.

According to one embodiment of the invention, the at least one rotation-locking member and the at least one rotation-locking component are configured to align a central axis of the drive wheel with the rotational axis when the main body is fastened to the lid. This thus prevents the pull string drive device and the work unit from deviating from the rotational axis and becoming misaligned relative to the bowl guide axis when the string is pulled or the food is pressed while being processed in the bowl.

According to one embodiment of the invention, the rotation-locking device forms an angular indexing device configured to define one or more assembly position(s) for the main body and the lid.

According to one embodiment of the invention, the fastening device and the rotation-locking device are separate from each other.

According to one embodiment of the invention, the lower housing forms the at least one rotation-locking member.

According to one embodiment of the invention, the at least one rotation-locking component comprises a rotation-locking projection that is provided on an upper surface of the lid and that is configured to be directed upwards when the work unit is resting on a horizontal surface, the rotation-locking projection being configured to extend, for example continuously or discontinuously, around the rotational axis.

According to one embodiment of the invention, the rotation-locking projection is configured to be arranged coaxially relative to the rotational axis.

According to one embodiment of the invention, the lower housing is configured to accommodate at least in part the rotation-locking projection when the main body is fastened to the lid.

According to one embodiment of the invention, the rotation-locking projection is polygonal in shape, for example hexagonal in shape. Advantageously, the rotation-locking projection has a shape that is complementary to that of the lower housing.

According to one embodiment of the invention, the rotation-locking projection comprises a locking rib extending from the upper surface of the lid and configured to be directed upwards when the work unit is resting on a horizontal surface, and a retaining rim projecting laterally outwards from the locking rib and away from the rotational axis, the retaining rim forming at least in part the at least one fastening component.

According to one embodiment of the invention, the retaining rim extends continuously or discontinuously around the rotational axis.

According to one embodiment of the invention, the locking rib and the retaining rim delimit at least one retaining housing. Advantageously, the retaining housing is ring-shaped and extends around the rotational axis.

According to one embodiment of the invention, the rotation-locking projection has a hook-shaped cross-section, so that the at least one fastening member can be hooked in.

According to one embodiment of the invention, the locking rib is directed upwards perpendicular to a main part of the lid that extends around the rotation-locking projection.

According to one embodiment of the invention, when the main body is fastened to the lid, the at least one rotation-locking member and the at least one rotation-locking component are further configured to prevent translational movement of the main body relative to the lid in the plane of travel.

According to another embodiment of the invention, the locking system could comprise a translation-locking device distinct from the rotation-locking device, the translation-locking device being configured to prevent, when the main body is fastened to the lid, translational movement of the main body relative to the lid along the plane of travel.

According to one embodiment of the invention, the rotary accessory comprises a coupling member and the drive wheel comprises a coupling component configured to be mechanically coupled to the coupling member when the main body is fastened to the lid, so as to transmit rotational movement from the drive wheel to the rotary accessory.

According to one embodiment of the invention, the lid comprises a central through-hole, the coupling member being configured to be located facing the through-hole or to project through the central through-hole, and the coupling component being configured to cooperate with the coupling member by mechanical coupling.

According to one embodiment of the invention, the mechanical coupling is of the male/female type.

According to one embodiment of the invention, the coupling component is a female coupling component, and the coupling member is a male coupling member.

According to one embodiment of the invention, the rotation-locking projection delimits a central housing provided with a bottom wall in which the central through-hole is formed.

According to one embodiment of the invention, the bottom wall comprises a bottom surface that extends around the central through-hole and converges downwards and towards the central through-hole.

According to one embodiment of the invention, the locking system is configured to prevent, to the nearest functional clearance, any movement of the main body relative to the lid when the main body is fastened to the lid.

According to another embodiment of the invention, the work unit comprises a drive interface that is mounted on the lid and configured to be rotationally attached to the coupling member, the drive interface being configured to cooperate with the coupling component provided on the drive wheel by mechanical coupling in order to transmit a rotational movement from the drive wheel to the rotary accessory.

According to one embodiment of the invention, the drive interface comprises a coupling housing configured to receive the coupling member.

According to one embodiment of the invention, the kitchen appliance comprises a connecting device, for example a bayonet fastening system or a locking system, configured to removably fasten the lid to the bowl. This effectively centers the lid on the bowl and keeps the axis of the lid aligned with the axis of the bowl, as well as with the rotation axis.

According to one embodiment of the invention, the connecting device comprises several connecting members provided on the bowl and distributed around the rotational axis, and several connecting components provided around the perimeter of the lid and configured to cooperate with the connecting members respectively. Advantageously, the connecting members are provided on the outside of an inner volume delimited by the bowl, and more specifically on an outer surface of the bowl, so as to make the bowl easier to clean.

According to one embodiment of the invention, the pull string drive device comprises a string guide that is fastened to the main body and that is configured to guide the string when the string is pulled. The presence of such a string guide prevents damage to the main body when the string moves back and forth. Advantageously, the string guide can be made of brass, ceramic or metal, or any material which, when in contact with the string, will not be altered by the heating of the string due to the friction of the string during its movement.

According to one embodiment of the invention, the string guide is tubular and delimits an inner channel configured to allow the string to pass through.

According to one embodiment of the invention, the main body of the pull string drive device comprises an offsetting component configured to move the handle away in a radial direction relative to the rotational axis and to tension the string in a radial direction relative to the rotational axis.

According to one embodiment of the invention, the return spring is wound around the rotational axis. The winding plane of the return spring is advantageously arranged perpendicular to the rotational axis.

According to one embodiment of the invention, the return spring is housed in a ring-shaped cavity delimited at least in part by the drive wheel.

According to one embodiment of the invention, the return spring comprises a first end portion fastened to a first anchoring point provided on the drive wheel, and a second end portion fastened to a second anchoring point provided on the main body. The return spring can thus store energy when it is taut or under tension, and release it when it is decompressed (torque release). The energy released is generally transmitted to the rotary accessory.

According to one embodiment of the invention, the return spring is a spiral spring, and for example an elastic band. Advantageously, the elastic band is wound into the cavity in the form of a roll with contiguous coils.

According to one embodiment of the invention, the drive wheel comprises a ring-shaped groove configured to receive the string. Advantageously, the drive wheel is a drum reel comprising a ring-shaped groove in which the string is housed as it winds around the rotational axis.

According to one embodiment of the invention, the string is wound counter-clockwise relative to the rotational axis in the ring-shaped groove of the drive wheel, and the return spring, which is arranged in the ring-shaped cavity of the drive wheel, is wound clockwise relative to the rotational axis. The string could conceivably be wound into the ring-shaped groove of the drive wheel, clockwise relative to the rotational axis, and the return spring could be arranged in the ring-shaped cavity of the drive wheel, wound counter-clockwise relative to the rotational axis.

According to one embodiment of the invention, the drive wheel is rotatable relative to the main body.

According to one embodiment of the invention, the kitchen appliance is a salad spinner, a chopper, a ricer, a juicer, a blender or any other kitchen appliance requiring a non-electric, manually-operated, self-retracting reel for transmitting movement from one part to another part by pulling a cable or string.

The present invention further relates to a pull string drive device for a kitchen appliance comprising a work unit comprising a bowl, a lid configured to close the bowl and a rotary accessory arranged in the bowl and rotatably mounted around a rotational axis, the pull string drive device comprising a main body, a drive wheel housed in the main body and configured to be arranged coaxially relative to the rotational axis, a string that is configured to be wound around the drive wheel and that comprises a first end fastened to the drive wheel and a second end opposite the first end, and a handle connected to the second end of the string and configured to pull on the string so as to rotate the drive wheel in one direction of rotation, the pull string drive device being configured to manually cause the rotary accessory to rotate around the rotational axis by pulling the string transversely to the rotational axis,
characterized in that the pull string drive device is self-contained and is configured to be removable relative to the lid, the main body being configured to be temporarily and reversibly fastened to the lid and being configured to be rotationally locked relative to the lid and along the rotational axis when the main body is fastened to the lid.

According to one embodiment of the invention, the main body comprises at least one fastening member configured to occupy a fastening position in which the at least one fastening member is configured to cooperate with at least one fastening component provided on the lid so as to fasten the main body to the lid, and a release position in which the at least one fastening member is configured to release the at least one fastening component so that the pull string drive device can be removed from the lid.

According to one embodiment of the invention, the main body comprises at least one rotation-locking member configured to cooperate with at least one rotation-locking member provided on the lid when the main body is fastened to the lid, so as to prevent, and more specifically to prohibit, rotational movement of the main body relative to the lid and along the rotational axis when the main body is fastened to the lid.

The purposes, aspects and advantages of the present invention will be better understood from the following description of specific embodiments of the invention provided as non-limiting examples, with reference to the appended drawings in which:

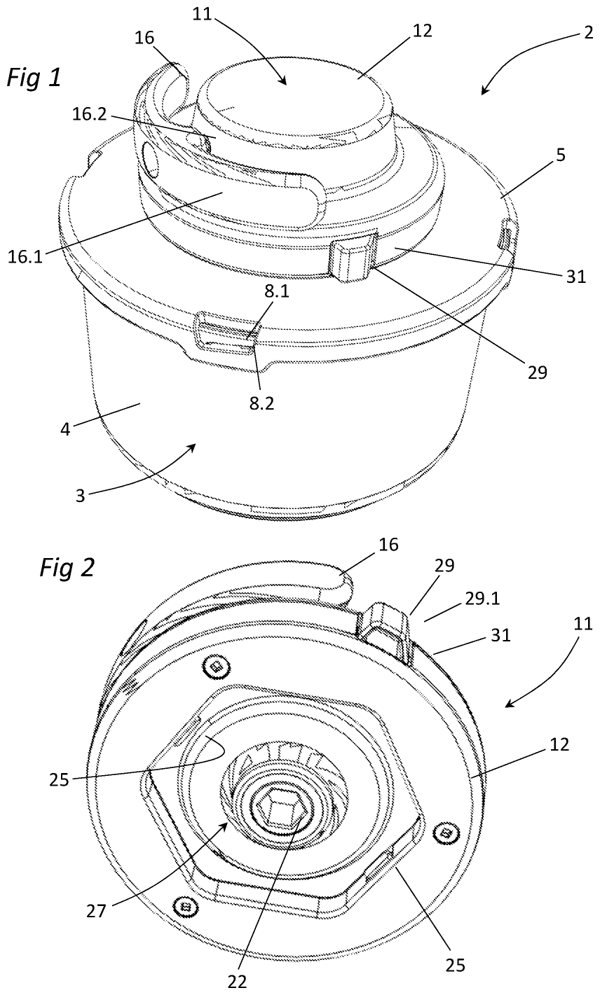

FIG. 1 is a perspective view of a kitchen appliance according to the invention, of the chopper type, comprising a work unit and a pull string drive device in a resting phase and fastened to a lid of the work unit.

FIG. 2 is a perspective view from underneath of the pull string drive device in a resting phase.

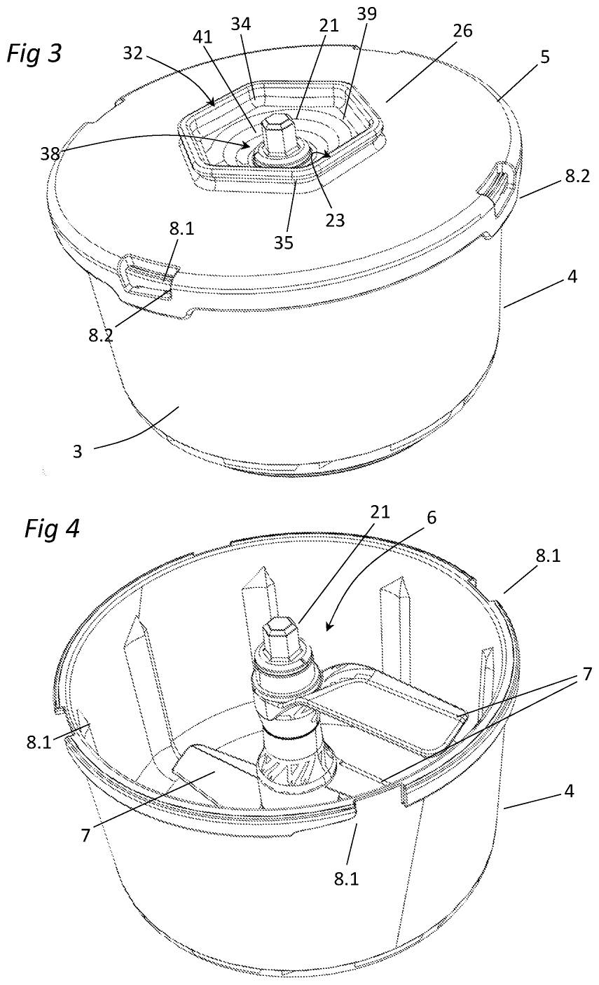

FIG. 3 is a top perspective view of the work unit.

FIG. 4 is a partial top perspective view of the work unit.

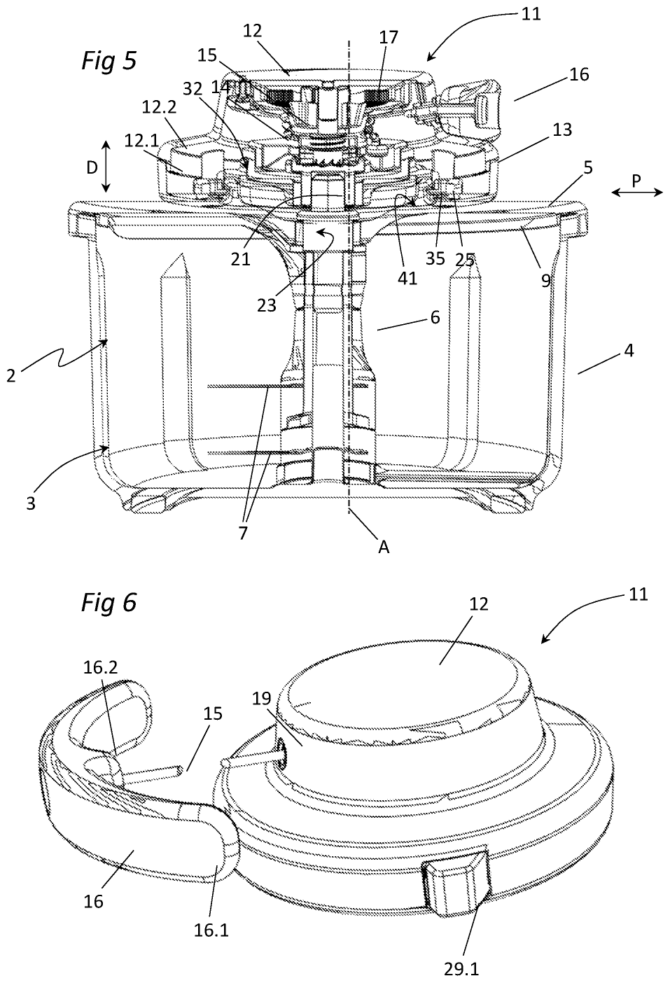

FIG. 5 is a longitudinal sectional view of the kitchen appliance shown in FIG. 1.

FIG. 6 is a perspective top view of the pull string drive device in a working phase.

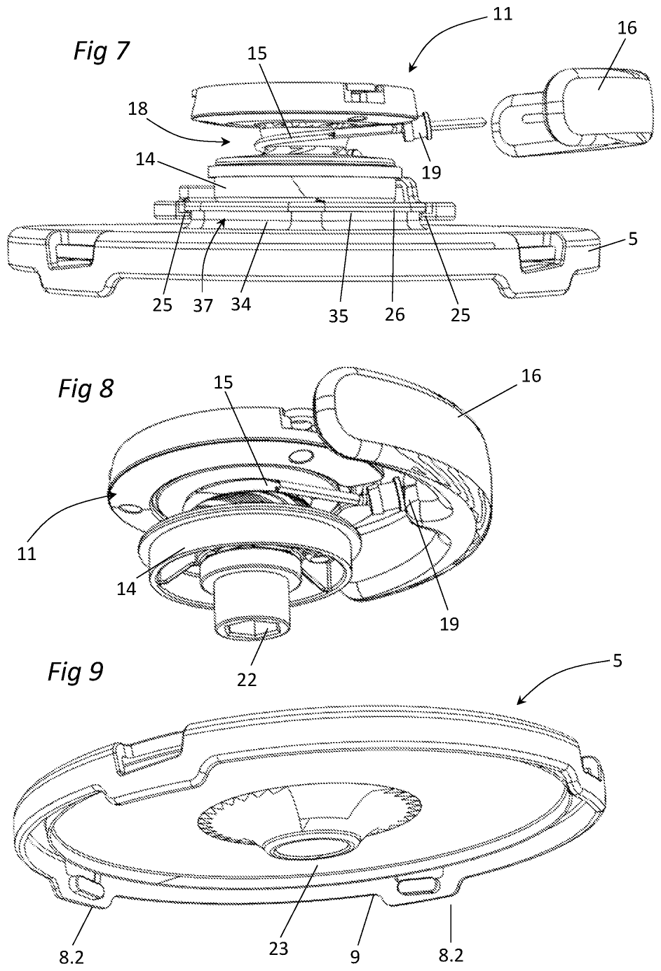

FIG. 7 is a partial side view of the pull string drive device in a working phase.

FIG. 8 is a partial perspective view from underneath of the pull string drive device in a resting phase.

FIG. 9 is a perspective view from underneath the lid.

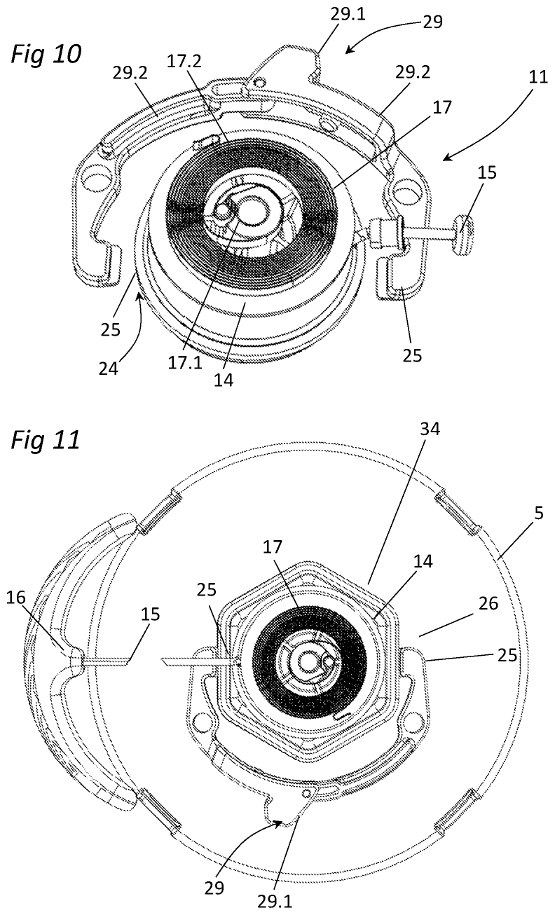

FIG. 10 is a partial perspective top view of the pull string drive device in a resting phase.

FIG. 11 is a partial top view of the pull string drive device in a working phase.

It should be noted that throughout this document, the terms “longitudinal”, “transverse”, “horizontal”, “vertical”, “lower”, “upper”, “top”, “bottom”, “coaxial”, “radial” used to describe the invention, refer to this invention when in use, when placed on a horizontal plane. Within the meaning of the invention, the term “coaxially” denotes that the parts are aligned on the same axis, without necessarily running through the geometric center of the parts.

In this document, “string” also refers to a cable, pull chain, strap or any other similar elongated pulling component that can be wound around a drive wheel. Such a string can be made of natural, metallic or plastic material.

FIGS. 1 to 11 show a kitchen appliance 2 according to the invention, of the chopper type. However, the kitchen appliance 2 could be a salad spinner, a ricer, a juicer, a blender or any other kitchen appliance 2 requiring a non-electric, manually-operated, self-retracting reel for transmitting movement from one part to another part by pulling a cable or string.

The kitchen appliance 2 comprises a work unit 3 comprising a bowl 4 delimiting an inner volume intended to contain food, a lid 5 configured to close the bowl 4 and a rotary accessory 6 arranged in the bowl 4 and rotatably mounted around a rotational axis A. According to the embodiment shown in FIGS. 1 to 11, the rotary accessory 6 is a cutting tool comprising one or more cutting blade(s) 7. However, the rotary accessory 6 could be a spin basket, a mixing tool, a kneading tool, a stirring tool, or any rotary work tool, also referred to as a rotary processing tool, configured to process food received in the bowl 4, and for example to mix, beat, whisk, grate, chop, cut, blend, combine, emulsify and/or knead food received in the bowl 4.

Advantageously, the kitchen appliance 2 comprises a connecting device 8, such as a bayonet fastening system, configured to removably fasten the lid 5 to the bowl 4. The connecting device 8 more specifically comprises several connecting members 8.1 provided on the bowl 4 and distributed around the rotational axis A, and several connecting components 8.2 provided around the perimeter of the lid 5 and configured to cooperate with the connecting members 8.1 respectively. Advantageously, the connecting members 8.1 are provided on the outside of the inner volume, and more specifically on an outer surface of the bowl 4, so as to make the bowl 4 easier to clean.

According to the embodiment shown in FIGS. 1 to 11, the lid 5 is equipped with a ring-shaped sealing lip 9 that is provided on a lower face of the lid 5 and is configured to cooperate with an upper peripheral edge of the bowl 4. The presence of such a ring-shaped sealing lip 9 considerably reduces the risk of food being splashed out of the bowl 4 as a result of centrifuging.

Advantageously, the connecting device 8 is configured to press the lid 5 against the upper peripheral edge of the bowl 4, so as to further increase the seal between the lid 5 and the bowl 4. To this end, as can be seen in FIG. 9, each of the connecting components 8.2 is sloped relative to the horizontal when the lid 5 is resting on a horizontal surface.

The kitchen appliance 2 also comprises a pull string drive device 11 configured to manually rotate the rotary accessory 6 around the rotational axis A.

The pull string drive device 11 comprises a main body 12 that forms a protective housing. For example, the main body 12 can comprise a base 12.1 and a protective cover 12.2 fastened to the base 12.1, with the base 12.1 and the protective cover 12.2 delimiting an inner housing 13. Advantageously, the protective cover comprises a gripping part enabling a user to easily lift the kitchen appliance 2 using the pull string drive device 11, and also to easily handle the pull string drive device 11.

The pull string drive device 11 further comprises:
a drive wheel 14 housed in the inner housing 13 delimited by the main body 12 and configured to be arranged coaxially relative to the rotational axis A, the drive wheel 14 being rotatably mounted relative to the main body 12,
a string 15 configured to be wound around the drive wheel 14, the string 15 comprising a first end fastened to the drive wheel 14 and a second end opposite the first end,
a handle 16 located outside the main body 12, the handle 16 being connected to the second end of the string 15 and being configured to pull on the string 15 so as to rotate the drive wheel 14 in one direction, and
a return spring 17 housed in the inner housing 13 delimited by the main body 12 and configured to be arranged coaxially relative to the rotational axis A, the return spring 17 being configured to rotate the drive wheel 14 in a reverse direction of rotation that is opposite to the direction of rotation, so as to wind the string 15 around the drive wheel 14 after the user has pulled on the handle 16.

The rotary accessory 6 is thus more specifically configured to chop food received in the bowl 4 by rotating the cutting blade(s) 7 when a user pulls on the handle 16 connected to the string 15.

Advantageously, the handle 16 comprises a gripping part 16.1 with a curved shape, for example generally in the form of a circular arc, and a stop part 16.2 configured to bear against an external surface of the main body 12 when the pull string drive device 11 is in the resting phase.

According to the embodiment shown in FIGS. 1 to 11, the return spring 17 is wound around the rotational axis A, and the winding plane of the return spring 17 is advantageously arranged perpendicular to the rotational axis A. Advantageously, the return spring 17 is a spiral spring, such as an elastic band in the form of a roll with contiguous coils, and is housed in a ring-shaped cavity delimited at least in part by the drive wheel 14.

As shown in FIG. 10, the return spring 17 comprises a first end portion 17.1 fastened to a first anchoring point provided on the drive wheel 14, and a second end portion 17.2 fastened to a second anchoring point provided on the main body 12. The return spring 17 can thus store energy when it is taut or under tension, and release it when decompressed (torque release).

As shown more specifically in FIG. 7, the drive wheel 14 comprises a ring-shaped groove 18 configured to receive the string 15. Advantageously, the string 15 is wound in the ring-shaped groove 18, counter-clockwise relative to the rotational axis A, and the return spring 17, which is arranged in the ring-shaped cavity of the drive wheel 14, is wound clockwise relative to the rotational axis A. However, the string 15 could be wound clockwise relative to the rotational axis A in the ring-shaped groove 18 of the drive wheel 14, and the return spring 17 could be arranged in the ring-shaped cavity of the drive wheel 14 wound counter-clockwise relative to the rotational axis A.

Advantageously, the pull string drive device 11 also comprises a string guide 19 that is fastened to the main body 12 and that is configured to guide the string 15 when the string 15 is pulled. The string guide 19 can for example be made of brass, ceramic or metal, or any material which, when in contact with the string 15, will not be altered by the heating of the string 15 due to the friction of the string during its movement. According to the embodiment shown in FIGS. 1 to 11, the string guide 19 is tubular and delimits an inner channel configured to allow the string 15 to pass through. Advantageously, the inner channel opens into an outer peripheral wall of the main body 12.

As shown more specifically in FIGS. 2 to 5, the rotary accessory 6 comprises a coupling member 21 and the drive wheel 14 comprises a coupling component 22 configured to be mechanically coupled to the coupling member 21 when the main body 12 is fastened to the lid 5, so as to transmit rotational movement from the drive wheel 14 to the rotary accessory 6. Advantageously, the coupling member 21 and the coupling component 22 each have a polygonal cross-section, for example hexagonal.

According to the embodiment shown in FIGS. 1 to 11, the lid 5 comprises a central through-hole 23, and the coupling member 21 is configured to be located facing the through-hole or to project through the central through-hole. Advantageously, the coupling component 22 is configured to cooperate directly with the coupling member 21 by a mechanical coupling of the male/female type. According to the embodiment shown in FIGS. 1 to 11, the coupling component 22 is a female coupling member, and the coupling member 21 is a male coupling member. However, the coupling component 22 could be a male coupling component, and the coupling member 21 could be a female coupling member.

As shown more specifically in FIGS. 2 and 6, the pull string drive device 11 is self-contained, and is configured to be removable relative to the lid 5.

To this end, the kitchen appliance 2 comprises a locking system 23 configured to fasten the main body 12 of the pull string drive device 11 temporarily and reversibly to the lid 5. The locking system 23 is further configured to:
prohibit any rotational movement of the main body 12 relative to the lid 5 and along the rotational axis A when the main body 12 is fastened to the lid 5,
prevent any translational movement of the main body 12 relative to the lid 5 in a direction of travel D that is parallel to the rotational axis A, when the main body 12 is fastened to the lid 5, and
prevent any translational movement of the main body 12 relative to the lid 5 in a plane of travel P that is orthogonal to the rotational axis A, when the main body 12 is fastened to the lid 5.

The locking system 23 is configured to immobilize the main body 12 in translation and in rotation relative to the lid 5 when the main body 12 is fastened to the lid 5. Advantageously, the locking system 23 is more specifically configured to prevent, to the nearest functional clearance, any movement of the main body 12 relative to the lid 5 when the main body 12 is fastened to the lid 5.

According to the embodiment shown in FIGS. 1 to 11, the locking system 23 comprises a fastening device 24 configured to fasten the main body 12 of the pull string drive device 11 temporarily and reversibly to the lid 5, and to prevent translational movement of the main body 12 relative to the lid 5 in the direction of travel D.

The fastening device 24 more specifically comprises two fastening members 25, such as fastening brackets, fastening pins or fastening clamps, at least partly housed in the main body 12 and arranged opposite each other. The two fastening members 25 are mounted so as to be movable relative to the main body 12 between a fastening position in which the first and second fastening members 25 are close to each other and are configured to cooperate with a fastening member 26 provided on the lid 5 and belonging to the fastening device 24, so as to fasten the main body 12 to the lid 5, and a release position in which the two fastening members 25 are spaced apart from each other and are configured to release the fastening member 26 so that the pull string drive device 11 can be removed from the lid 5.

As shown in FIGS. 5, 7 and 11, the two fastening members 25 are arranged in a lower part of the main body 12, and are each hinge-mounted relative to the main body 12 around a respective hinge pin that is configured to be parallel to the rotational axis A when the main body 12 is fastened to the lid 5.

Advantageously, the main body 12 comprises a lower housing 27 (see FIG. 2) that is open downwards and that opens into a lower face of the main body 12. The lower housing 27 is configured to accommodate at least in part the fastening component 26 provided on the lid 5 when the main body 12 is fastened to the lid 5, and the two fastening members 25 are configured to project into the lower housing 27 when they occupy the fastening position. The lower housing 27 can have a polygonal cross-section, and for example hexagonal.

According to the embodiment shown in FIGS. 1 to 11, the fastening component 26 is formed by a retaining rim (which will be described in more detail below) provided on the lid 5 and extending continuously around the rotational axis A. However, the retaining rim could extend discontinuously around the rotational axis A. The two fastening members 25 are thus more specifically configured to hook under the retaining rim when the two fastening members 25 occupy the fastening position.

According to the embodiment shown in FIGS. 1 to 11, the fastening device 24 comprises a return means (not shown in the figures) configured to return the fastening members 25 to the fastening position, and an actuating mechanism 29 provided on the pull string drive device 11 and configured to move the fastening members 25 to the release position when the actuating mechanism 29 is operated by a user. Advantageously, the actuating mechanism 29 is housed at least in part in the main body 12 and comprises an actuating part 29.1 configured to project through an opening in the body 31 provided on an outer peripheral wall of the main body 12, and thus to be accessible by a user.

According to the embodiment shown in FIGS. 1 to 11, the actuating mechanism 29 further comprises two connecting arms 29.2 which are attached respectively to the two fastening members 25, and which are mounted so as to be movable relative to each other. The actuating part 29.1 is more specifically provided on one of the connecting arms 29.2. Each connecting arm 29.2 can, for example, be made in a single part with the respective fastening member 25.

Advantageously, one of the connecting arms 29.2 is provided with a guide slot, for example in the shape of a circular arc, and the other of the connecting arms 29.2 is provided with a guide pin slidably mounted in the guide slot, so that when pressure is exerted by a user on the actuating part 29.1, the guide pin slides in the guide slot, and the two connecting arms 29.2 are moved radially in the direction of the rotational axis A. Such movement of the two connecting arms 29.2 causes the two fastening members 25 to move apart, and thus to move into the release position.

The locking system 23 further comprises a rotation-locking device 32 configured to prevent, and more specifically to prohibit, rotational movement of the main body 12 relative to the lid 5 and along the rotational axis A when the main body 12 is fastened to the lid 5.

The rotation-locking device 32 comprises a rotation-locking member provided on the main body 12, and a rotation-locking component that is provided on the lid 5 and configured to cooperate with the rotation-locking member when the main body 12 is fastened to the lid 5. Advantageously, the rotation-locking member and the rotation-locking component are also configured to align a central axis of the drive wheel 14 with the rotational axis A when the main body 12 is fastened to the lid 5.

According to the embodiment shown in FIGS. 1 to 11, the rotation-locking member is formed by the lower housing 27, and the rotation-locking component comprises a rotation-locking projection 34 that is provided on an upper surface of the lid 5 and that is configured to be directed upwards when the work unit 3 is resting on a horizontal surface.

The rotation-locking projection 34 is configured to extend, for example continuously or discontinuously, around the rotational axis A, and is arranged coaxially relative to the rotational axis A. Advantageously, the lower housing 27 is configured to accommodate the rotation-locking projection 34 at least in part when the main body 12 is fastened to the lid 5, and the rotation-locking projection 34 has a complementary shape to that of the lower housing 27. The rotation-locking projection 34 is advantageously polygonal in shape, for example hexagonal in shape.

According to the embodiment shown in FIGS. 1 to 11, the rotation-locking projection 34 comprises:
a locking rib 35 extending from the upper surface of the lid 5 and configured to be directed upwards when the work unit 3 is resting on a horizontal surface, and
the retaining rim (which forms the fastening component 26), which projects laterally outwards from the locking rib 35 and away from the rotational axis A.

The rotation-locking protrusion 34 thus has a hook-shaped cross-section, so that the two fastening members 25 are optimally hooked together when they occupy the fastening position. Advantageously, the locking rib 35 and the retaining rim delimit a ring-shaped retaining housing 37, which extends around the rotational axis A and is configured to at least partially accommodate the two fastening members 25.

According to the embodiment shown in FIGS. 1 to 11, the rotation-locking projection 34 delimits a central housing 38 provided with a bottom wall 39 in which the central through-hole 23 is formed. The bottom wall 39 comprises a bottom surface 41 that extends around the central through-hole 23 and converges downwards and towards the central through-hole 23. This configuration of the rotation-locking protrusion 34 and of the lid 5 makes it possible to contain and redirect towards the central through-hole 23, and therefore towards the bowl 4, any liquid foodstuffs that may have been splashed through the central through-hole 23 when the rotary accessory 6 was rotated.

According to the embodiment shown in FIGS. 1 to 11, the rotation-locking member and the rotation-locking component are further configured to prevent translational movement of the main body 12 relative to the lid 5 in the plane of travel, when the main body 12 is fastened to the lid 5. However, according to another embodiment of the invention, the locking system 23 could comprise a rotation-locking device separate from the translation-locking device 32 and configured to prevent translational movement of the main body 12 relative to the lid 5 in the plane of travel, when the main body 12 is fastened to the lid 5.

According to an embodiment of the invention not shown in the figures, the fastening device 24 could comprise one or more fastening component(s) provided on the lid 5, the or each fastening component 26 being provided with a fastening hole configured to accommodate at least in part a respective fastening member 25, such as a hooking tab, provided on the main body 12, when said fastening member 25 occupies the fastening position. The fastening device 24 could, for example, comprise two fastening brackets on the lid 5, each with a fastening hole, or two fastening hoops on the lid 5, each delimiting a fastening hole.

According to an embodiment of the invention not shown in the figures, the work unit 3 comprises a drive interface that is mounted on the lid 5 and is configured to be rotationally attached to the coupling member 21, the drive interface being configured to cooperate with the coupling member 22 provided on the drive wheel 14 by mechanical coupling in order to transmit a rotational movement from the drive wheel 14 to the rotary accessory 6. For example, the drive interface can comprise a coupling housing configured to receive the coupling member 21.

Although the invention has been described in relation to particular exemplary embodiments and applications, it is obviously in no way limited thereto.

Changes can still be made, particularly with regard to the arrangement and composition of the various elements or by substituting equivalent techniques, without departing from the scope of protection of the invention.

1. A kitchen appliance, comprising:
a work unit comprising a bowl, a lid configured to close the bowl and a rotary accessory arranged in the bowl and rotatably mounted around a rotational axis;
a pull string drive device comprising a main body, a drive wheel housed in the main body and configured to be arranged coaxially relative to the rotational axis, a string that is configured to be wound around the drive wheel and that comprising a first end fastened to the drive wheel and a second end opposite the first end, and a handle connected to the second end of the string and configured to pull on the string so as to rotate the drive wheel in one direction of rotation, the pull string drive device being configured to manually cause the rotary accessory to rotate around the rotational axis by pulling the string transversely to the rotational axis;
wherein the pull string drive device is self-contained and is configured to be removable relative to the lid, and in that the kitchen appliance comprises a locking system configured to fasten the main body of the pull string drive device temporarily and reversibly to the lid, the locking system being further configured to prevent rotational movement of the main body relative to the lid and along the rotational axis when the main body is fastened to the lid.

2. The kitchen appliance according to claim 1, wherein the locking system is configured to prevent, when the main body is fastened to the lid, translational movement of the main body relative to the lid in a direction of travel that is parallel to the rotational axis, and translational movement of the main body relative to the lid in a plane of travel that is orthogonal to the rotational axis.

3. The kitchen appliance according to claim 1, wherein the locking system comprises a fastening device configured to fasten the main body of the pull string drive device temporarily and reversibly to the lid, the fastening device comprising at least one fastening member provided on the main body and at least one fastening component provided on the lid, the at least one fastening member being configured to occupy a fastening position in which the at least one fastening member is configured to cooperate with the at least one fastening component so as to fasten the main body to the lid, and a release position in which the at least one fastening member is configured to release the at least one fastening component so that the pull string drive device can be removed from the lid.

4. The kitchen appliance according to claim 3, wherein the at least one fastening member is mounted so as to be movable relative to the main body between the fastening position and the release position.

5. The kitchen appliance according to claim 4, wherein the fastening device comprises a return means configured to return the at least one fastening member to the fastening position.

6. The kitchen appliance according to claim 3, further comprising an actuating mechanism configured to move the at least one fastening member into the release position when the actuating mechanism is operated by a user.

7. The kitchen appliance according to claim 6, wherein the actuating mechanism is provided on the pull string drive device.

8. The kitchen appliance according to claim 3, wherein the main body comprises a lower housing that opens into a lower face of the main body, the lower housing being configured to accommodate at least in part the at least one fastening component provided on the lid when the main body is fastened to the lid.

9. The kitchen appliance according to claim 8, wherein the lower housing has a polygonal cross-section, and for example hexagonal.

10. The kitchen appliance according to claim 8, wherein the at least one fastening member is configured to project into the lower housing when the at least one fastening member occupies the fastening position.

11. The kitchen appliance according to claim 3, wherein the fastening device comprises two fastening members mounted so as to be movable relative to the main body between a fastening position in which the first and second fastening members are close to each another and are configured to cooperate with the at least one fastening member provided on the lid, and a release position in which the two fastening members are spaced apart from each other and are configured to release the at least one fastening component.

12. The kitchen appliance according to claim 1, wherein the locking system comprises a rotation-locking device configured to prevent rotational movement of the main body relative to the lid and along the rotational axis when the main body is fastened to the lid, the rotation-locking device comprising at least one rotation-locking member provided on the main body and at least one rotation-locking component that is provided on the lid and that is configured to cooperate with the at least one rotation-locking member when the main body is fastened to the lid.

13. The kitchen appliance according to claim 8, wherein the locking system comprises a rotation-locking device configured to prevent rotational movement of the main body relative to the lid and along the rotational axis when the main body is fastened to the lid, the rotation-locking device comprising at least one rotation-locking member provided on the main body and at least one rotation-locking component that is provided on the lid and that is configured to cooperate with the at least one rotation-locking member when the main body is fastened to the lid, and wherein the lower housing forms the at least one rotation-locking member.

14. The kitchen appliance according to claim 12, wherein the at least one rotation-locking component comprises a rotation-locking projection that is provided on an upper surface of the lid and that is configured to be directed upwards when the work unit is resting on a horizontal surface, the rotation-locking projection being configured to extend around the rotational axis.

15. The kitchen appliance according to claim 14, wherein the rotation-locking projection is polygonal in shape.

16. The kitchen appliance according to claim 14, wherein the locking system comprises a fastening device configured to fasten the main body of the pull string drive device temporarily and reversibly to the lid, the fastening device comprising at least one fastening member provided on the main body and at least one fastening component provided on the lid, the at least one fastening member being configured to occupy a fastening position in which the at least one fastening member is configured to cooperate with the at least one fastening component so as to fasten the main body to the lid, and a release position in which the at least one fastening member is configured to release the at least one fastening component so that the pull string drive device can be removed from the lid, and wherein the rotation-locking projection comprises a locking rib that extends from the upper surface of the lid and is configured to be directed upwards when the work unit is resting on a horizontal surface, and a retaining rim projecting laterally outwards from the locking rib and away from the rotational axis, the retaining rim forming at least in part the at least one fastening component.

17. The kitchen appliance according to claim 12, wherein, when the main body is fastened to the lid, the at least one rotation-locking member and the at least one rotation-locking component are further configured to prevent translational movement of the main body relative to the lid in the plane of travel.

18. The kitchen appliance of claim 1, wherein the rotary accessory comprises a coupling member and the drive wheel comprises a coupling component configured to be mechanically coupled to the coupling member when the main body is fastened to the lid, so as to transmit rotational movement from the drive wheel to the rotary accessory.

19. The kitchen appliance according to claim 18, wherein the lid comprises a central through-hole, the coupling member being configured to accommodate the two fastening members at least partially be located facing the through-hole or to project through the central through-hole, and the coupling component being configured to cooperate with the coupling member by mechanical coupling.

20. The kitchen appliance according to claim 14, wherein the lid comprises a central through-hole, the coupling member being configured to accommodate the two fastening members at least partially be located facing the through-hole or to project through the central through-hole, and the coupling component being configured to cooperate with the coupling member by mechanical coupling, and wherein the rotation-locking projection delimits a central housing provided with a bottom wall in which the central through-hole is formed.

21. The kitchen appliance according to claim 20, wherein the bottom wall comprises a bottom surface that extends around the central through-hole and converges downwards and towards the central through-hole.

22. The kitchen appliance according to claim 1, wherein the locking system is configured to prevent, to the nearest functional clearance, any movement of the main body relative to the lid-when the main body is fastened to the lid.

23. A pull string drive device for a kitchen appliance comprising a work unit comprising a bowl, a lid configured to close the bowl and a rotary accessory arranged in the bowl and rotatably mounted around a rotational axis, the pull string drive device comprising a main body, a drive wheel housed in the main body and configured to be arranged coaxially relative to the rotational axis, a string that is configured to be wound around the drive wheel and that comprises a first end fastened to the drive wheel and a second end opposite the first end, and a handle connected to the second end of the string and configured to pull on the string so as to rotate the drive wheel in one direction of rotation, the pull string drive device being configured to manually cause the rotary accessory to rotate around the rotational axis by pulling the string transversely to the rotational axis,
characterized in that the pull string drive device is self-contained and is configured to be removable relative to the lid, the main body being configured to be temporarily and reversibly fastened to the lid and being configured to be rotationally locked relative to the lid and along the rotational axis when the main body is fastened to the lid.

24. The kitchen appliance according to claim 15, wherein the locking system comprises a fastening device configured to fasten the main body of the pull string drive device temporarily and reversibly to the lid, the fastening device comprising at least one fastening member provided on the main body and at least one fastening component provided on the lid, the at least one fastening member being configured to occupy a fastening position in which the at least one fastening member is configured to cooperate with the at least one fastening component so as to fasten the main body to the lid, and a release position in which the at least one fastening member is configured to release the at least one fastening component so that the pull string drive device can be removed from the lid, and wherein the rotation-locking projection comprises a locking rib that extends from the upper surface of the lid and is configured to be directed upwards when the work unit is resting on a horizontal surface, and a retaining rim projecting laterally outwards from the locking rib and away from the rotational axis, the retaining rim forming at least in part the at least one fastening component.
